(19) United States
(12) Patent Application Publication
(10) Pub. No.: US 2015/0353254 A1
(43) Pub. Date: Dec. 10, 2015

(54) FLEXIBLE CONTAINER FOR PORTABLE BEVERAGES

(71) Applicant: Jonathan Pauly, Chandler, AZ (US)

(72) Inventor: Jonathan Pauly, Chandler, AZ (US)

(21) Appl. No.: 14/619,204

(22) Filed: Feb. 11, 2015

Related U.S. Application Data
(60) Provisional application No. 61/997,760, filed on Jun. 10, 2014.

(51) Int. Cl. B65D 75/58; B65D 85/00; A23L 2/56; B65D 35/44; B65D 35/24

(52) U.S. Cl. CPC B65D 75/5861; B65D 35/44; B65D 35/245; A23L 2/56; B65D 85/70; A23V 2002/00

(57) ABSTRACT

A flexible container for providing dietary supplements comprising: a first position, where the first position compacted; a second position, where the second position is expanded; a spout at a top portion of the container; and a removable cap sealing the spout. Preferably, the first position folds into a compact form for portability. The container may include a dietary supplement in the form of a mixable powder within the container. In one particular embodiment, the flexible container also includes a clip to attach the container to a belt loop or gym bag.

### BACKGROUND OF THE INVENTION

1. Field of Invention

The present invention relates to a flexible container used to provide use with a powdered substance such as a dietary supplement or other mixed drink.

2. Description of Related Art

Many individuals use sports or protein-based drinks as part of their regular physical fitness regiment. Many times these beverages need to be consumed immediately following or before an exercise routine. Individuals may normally carry containers that allow them to consume the beverage or at least provide the substance of the supplemental so that water or other liquid may be added to that substance for consumption. Most of the time these containers or shakers take up additional space in bags and may become cumbersome to transport along with other items in an individual's gym bag. As a consequence it would be advantageous to have a small flexible container that can be easily folded or reduced in size therefore providing a portable option that could easily fit into an individual's bag pocket or purse.

### SUMMARY OF THE INVENTION

The present invention relates to a flexible container for providing dietary supplements comprising: a first position, where the first position compacted; a second position, where the second position is expanded; a spout at a top portion of the container; and a removable cap sealing the spout. Preferably, the first position folds into a compact form for portability. The container may include a dietary supplement or other beverage in the form of a mixable powder within the container. In one particular embodiment, the flexible container also includes a clip to attach the container to a belt loop or gym bag.

### BRIEF DESCRIPTION OF DRAWINGS

FIG. 1 depicts a flexible container in accordance with the present invention in a folded position.

FIG. 2 depicts the flexible container according to the present invention in an expanded position.

### DETAILED DESCRIPTION

The present invention relates to a flexible container that may be easily folded into a compact position so that it may easily fit into an individual's pocket, gym bag or purse. The flexible container according to present invention may also include a spout that includes a removable cap so that the individual may then add any liquid to the interior of the container. Once the container is filled with liquid for any type of powdered dietary supplement such as protein, creatine or otherwise may be easily mixed by shaking the container for consumption by the user. In additional to use for a dietary supplement, any type of mixable beverage may be produced with the

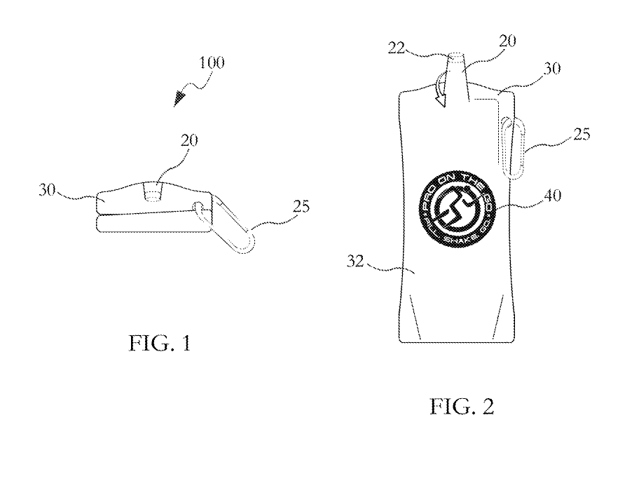

In reference to FIG. 1, a flexible container 100 in accordance with the present invention is depicted in a folded position. This container 100 includes top fold up portion 30 that further comprises a spout 20. The spout 20 is folded downward into the top portion 30 of the container 100. Alternatively, the spout 20 may be collapsed into the container 100 and released when needed. Further attached to the container 100 is a clip 25 that provides an easy mechanism for attaching the container to a user's body. This clip may also be easily attached to a gym bag, purse or a belt loop. In this folded position, the container 100 may also be easily placed in an individual's pocket without use of the clip 25.

In reference to FIG. 2, the flexible container 100 is shown in an expanded position where the popup portion 30 is extended and the spout is 20 is in the upright position. Spout 20 further includes a cap 22 that's easily twisted to remove and open the interior of the container 100. The container 100 includes a main portion or a main compartment 32 that has a logo 40 on the one side thereof. During use, the user may easily fill the container with water or other liquids in order to consume the supplements within the container. In one particular embodiment supplements in a powdered form are pre-loaded within the container 100 for consumption by the consumer. Further consumers may also add further supplements or powders into the containers through spout 20 for consumption.

Preferably the flexible container is made from a polyurethane material or other moldable plastic with aluminum that allows the container to easily fold and be reduced in size for portability. This folding capability therefore helps to reduce the size of the container and as a consequence makes it a practical and transportable container. The container may hold various types of supplements such as protein, sports electrolyte powder, creatine, amino acids or other commonly used vitamin and mineral supplements. Further the powder mix may be any consumable beverage such as lemonade, fruit mix or any other flavored drink mix, which requires a liquid for mixing. The instant invention has been shown and described in what it considers to be the most practical and preferred embodiments. It is recognized, however, that departures may be made there from within the scope of the invention and that obvious modifications will occur to a person skilled in the art.

What is claimed is:

1. A flexible container for providing dietary supplements comprising:
a. a first position, where the first position compacted;
b. a second position, where the second position is expanded;
c. a spout at a top portion of the container; and
d. a removable cap sealing the spout.

2. The flexible container according to claim 1, the first position is folded into a compact form.

3. The flexible container according to claim 1, where the container includes a flavored mix drink.

4. The flexible container according to claim 3, where the flavored mix drink is a dietary supplement within the container.

5. The flexible container according to claim 1, where the top portion folds downward to conceal the spout.

6. The flexible container according to claim 1, further including a clip.

7. The flexible container according to claim 4, where the dietary supplement includes a mixable powder.

8. The flexible container according to claim 7, where the mixable powder includes at least one of protein, electrolytes, creatine, carbohydrates and amino acids.
